(19) United States
(12) Patent Application Publication
(10) Pub. No.: US 2016/0182413 A1
(43) Pub. Date: Jun. 23, 2016

(54) Device and Its Method for Post-Processing Conversation Contents in a Communication Software

(71) Applicant: Yun Hung Shen, Hsinchu City (TW)

(72) Inventor: Yun Hung Shen, Hsinchu City (TW)

(21) Appl. No.: 14/578,497

(22) Filed: Dec. 22, 2014

(51) Int. Cl. H04L 12/58; G06F 3/0486; G06F 17/30; G06F 3/0484; G06F 3/0482

(52) U.S. Cl. CPC H04L 51/046; H04L 51/16; G06F 3/04842; G06F 3/0482; G06F 17/30705; G06F 3/0486; G06F 17/30864

(57) ABSTRACT

The communication device (such as mobiles, computers etc.) comprises: a processor, a storage media, a communication software, a conversation content processing module, wherein said storage media, such as cloud storages or general hard disks, is coupled with the processor; a communication software including a conversation content and a input dialog is coupled with the processor and the storage media for inputting some messages into the input dialog as the conversation content and storing the conversation content provided by the communication software in the storage media; a display coupled with the processor to display a scene of communication software. The conversation content processing module further includes four modules, and the four modules are web access module, interpose module, scheduling module and filing module, respectively.

### TECHNICAL FIELD

Embodiments of the invention generally relate to message post-processing and, more particularly, to a device and its method for post-processing conversation contents in a communication software.

### BACKGROUND OF RELATED ART

Over years, because of advances in information technology, people use the instant messaging software as a main way for transmitting messages instead of writing e-mail. The general text message, voice call, video and different size of files may be transmitted by instant messaging software, but in the past the instant messaging software is only operated in the general personal computer; in recent years, as smartphones and applications (App) are now in common use all over the world, the instant messaging software is not used only in the general personal computer, but also executed by the smartphone.

Currently the instant messaging software executed by the smartphone goes deep into life, and it is convenient for each user to log in and chat instantly. On the other hand, the instant messaging software in the smartphone may also be provided users for communicating and transmitting text message, voice call, video and different size of files (such as photos, figures) to other people. While users chat to other people by using the communication software (e.g. LINE, Wechat etc.), there are many conversation contents produced from chatting and stored in the storage media in users smartphones. The conversation contents often include some useful information (e.g. interesting things, dates, key words etc.), but some useful information often is poorly used because there are a fewer functional modules for post-processing some useful information of conversation contents in the communication software immediately. For example, if people use LINE to chat about the date for lunch but don't record the date instantly, they maybe forget the date. Therefore, if we could develop one software to post-process some useful information of conversation contents, the information in the conversation content will be post-proceeded effectively according to our need.

### SUMMARY

A device and its method for post-processing conversation contents in a communication software.

The purpose of the invention is to provide post-processing functions for conversation contents in a communication software. While users chat to other people by using the communication software (e.g. LINE, Wechat etc.), there are many conversation contents produced from chatting and stored in the storage media in user communication devices (e.g. mobiles). The conversation contents often include some useful information (e.g. interesting things, dates, key words etc.), but some useful information often is poorly used because there are a fewer functional modules for post-processing some useful information of conversation contents in the communication software immediately. The main purpose of the invention is to provide several functions for general users to post-process the conversation contents.

In a first aspect of the invention, the communication device (such as mobiles, computers etc.) comprises: a processor, a storage media, a communication software, a conversation content processing module and a display, wherein said storage media, such as cloud storages (Microsoft SkyDrive, Google Drive and Apple iTunes) or general hard disks coupled with the processor, including CPU, buffer, multiplexer and other process elements; a communication software including conversation contents and a input dialog is coupled with the processor and the storage media for inputting some messages into the input dialog as the conversation content and storing the conversation content provided by the communication software in the storage media; the display coupled with the processor to display conversation contents and the input dialog of communication software. The communication device further comprises a first and second wireless (including a wifi module and a RF module) transmission module which is coupled with the processor for connecting with another communication device and transmitting the message from the input dialog to another communication device as a part of the conversation content. In some embodiments, the conversation content processing module further includes four modules, and the four modules are web access module, interpose module, scheduling module and filing module, respectively. The four modules in the conversation content processing module may post-process the conversation content and be coupled with the communication software, so the conversation content in the communication software is no longer as a record use only. In some embodiments, the four modules may exist independently of the conversation content processing module. In some embodiments, said conversation contents in a communication software are stored in said storage media in said communication device having the display and one of four modules.

In a second aspect of the invention, the invention discloses a post-processing method for conversation contents in a communication software stored in a storage media in a communication device having a display and a scheduling module in said storage media. The procedure of the method comprises: displaying said conversation contents and selecting one of said conversation contents from said storage media such as cloud storages (Microsoft SkyDrive, Google Drive and Apple iTunes) or general hard disks (such as mobiles and USB flash drives); touching a date/time stored in said selected conversation content on the display; connecting said communication software with a calendar via a scheduling module; searching and recording a corresponding date/time on said calendar according to the date/time.

In a third aspect of the invention, the invention discloses a post-processing method for conversation contents in a communication software stored in a storage media in a communication device having a display and a interpose module in said storage media. The procedure of the method comprises: starting a communication software, displaying said conversation contents and selecting one of said conversation contents which is from the communication software stored in a storage media such as cloud storages (Microsoft SkyDrive, Google Drive and Apple iTunes) or general hard disks (such as mobiles and USB flash drives), then selecting and replicating at least one word of said selected conversation content; pasting said at least one word of said selected conversation content in a input dialog via said interpose module; inputting a message below said at least one word of said selected conversation content in a input dialog as one part of said selected conversation content.

While inputting a message below the at least one word of the conversation content in a input dialog as one part of said selected conversation content, another communication device may receive the message from the communication device.

In a fourth aspect of the invention, the invention discloses a post-processing method for conversation contents in a communication software stored in a storage media in a communication device having a display and a Web access module in said storage media, the procedure of the method comprises: displaying said conversation contents and selecting one of said conversation contents which are from the communication software stored in a storage media such as cloud storages (Microsoft SkyDrive, Google Drive and Apple iTunes) or general hard disks (such as mobiles and USB flash drives); the user may select at least one word of said selected conversation content and connect said communication software with a network via said Web access module which is in the conversation content processing module for searching an information related to said at least one word.

In a fifth aspect of the invention, the invention provides a post-processing method for conversation contents in a communication software stored in a storage media in a communication device having a display and a filing module in said storage media, the procedure of the method comprises: upon logging in the communication software, the user may display said conversation contents and use a filing module from said conversation processing module to create at least one subdirectory under a directory for classifying chatting contents with someone; selecting and replicating one of said conversation contents; pasting said selected conversation content into the at least one subdirectory; and writing a note for said selected conversation content placed in the at least one subdirectory via said filing module.

In addition, the conversation content processing module of the invention may be used with different communication software including but not limited to LINE, Wechat, Skype, Facebook conversation etc. Each module in the conversation content processing module of the invention may utilize the conversation content directly and doesn't need to start other applications.

### BRIEF DESCRIPTION OF THE DRAWINGS

Embodiments of the invention are illustrated by way of example, and not by way of limitation, in the figures of the accompanying drawings in which like reference numerals refer to similar elements:

FIG. 1 illustrates as a block diagram of a basic structure and its application structure of a device according to one embodiment;

FIG. 2 illustrates a process for scheduling date/time from conversation contents according to one embodiment;

FIG. 3 illustrates a process for interposing conversation contents according to one embodiment;

FIG. 4 illustrates a process for Web accessing using a conversation content processing module according to one embodiment; and

FIG. 5 illustrates a process for filing the conversation contents according to one embodiment of the invention.

### DETAILED DESCRIPTION

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

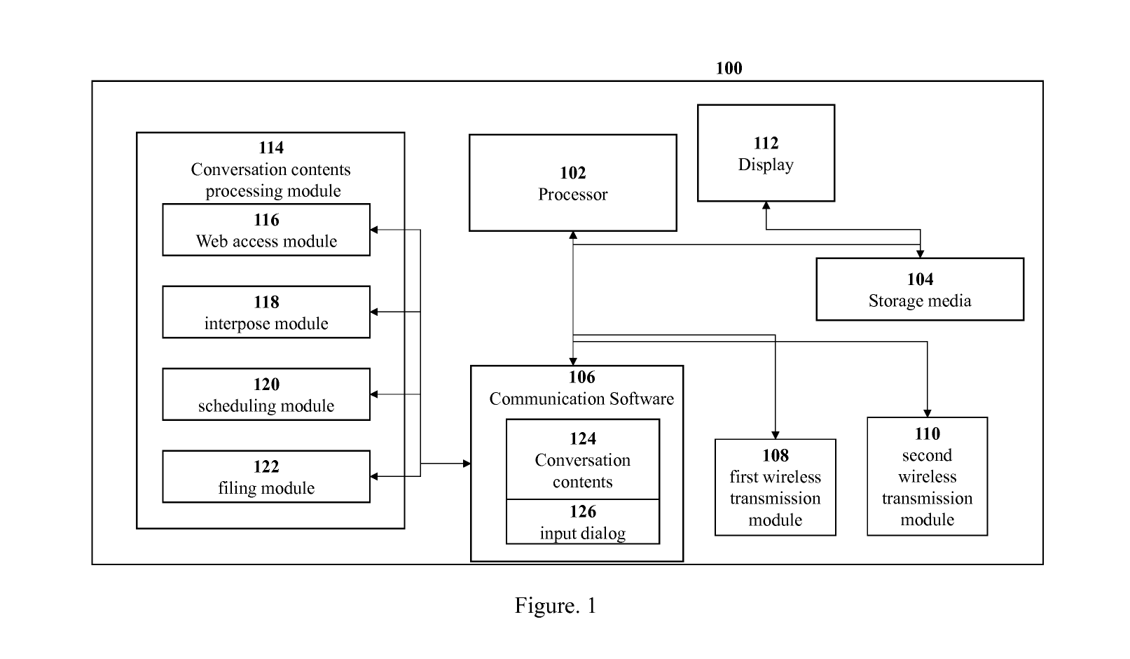

Embodiments of the invention are directed to for post-processing conversation contents in a communication software. As shown in FIG. 1, it is illustrated as a block diagram of a basic structure and its application structure of a device 100. The embodiment of the device 100 may include: a processor 102, a storage media 104, a communication software 106, a first 108 and second 110 wireless transmission module, a display 112 and a conversation content processing module 114; a conversation content processing module 114 further comprises: a Web access module 116, a interpose module 118, a scheduling module 120, a filing module 122. In some embodiments, when the communication software 106 is used by users, the communication software may show conversation contents 124 and a input dialog 126, wherein said storage media, such as cloud storages (Microsoft SkyDrive, Google Drive and Apple iTunes) or general hard disks coupled with the processor, including CPU, buffer, multiplexer and other process elements; a communication software includes a conversation content and a input dialog is coupled with the processor and the storage media for inputting some messages into the input dialog as the conversation content and storing the conversation content provided by the communication software in the storage media; a display coupled with the processor to display a scene of communication software.

The communication device further comprises a first and second wireless (including a wifi module and a RF module) transmission module which is coupled with the processor for connecting with another communication device and transmitting the message from the input dialog to another communication device as a part of the conversation content. In some embodiments, the conversation content processing module further includes four modules, and the four modules are web access module, interpose module, scheduling module and filing module, respectively. The four modules in the conversation content processing module may post-process the conversation content and be coupled with the communication software, so the conversation content is no longer as a record use only. In some embodiments, the four modules may exist independently of the conversation content processing module. As above mentioned, said conversation contents in a communication software are stored in said storage media in said communication device having the display and one of four modules (web access module, interpose module, scheduling module and filing module).

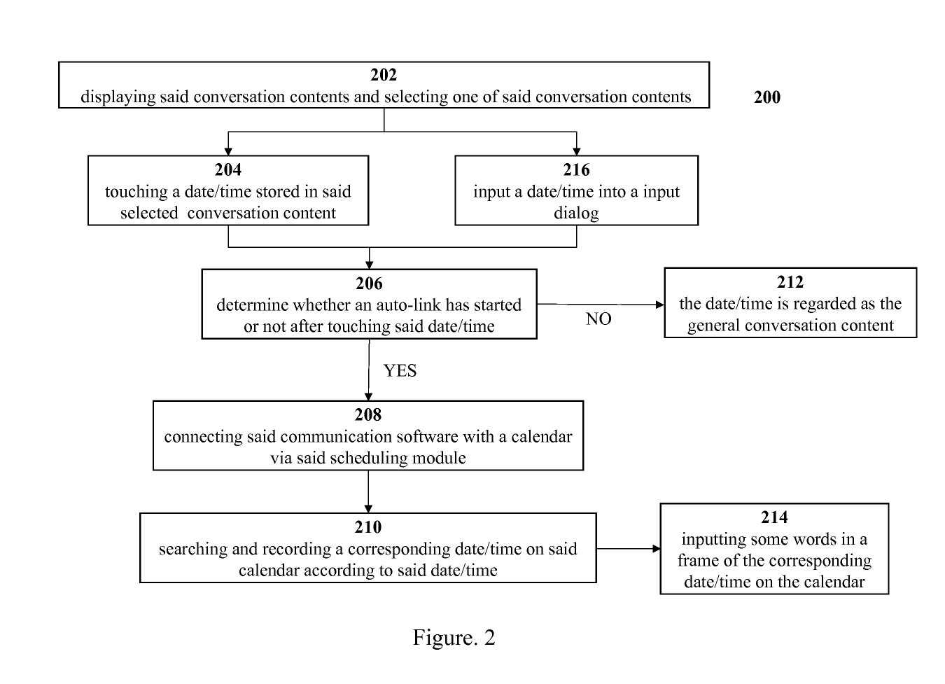

FIG. 2 illustrates a process for scheduling date/time from conversation contents according to one embodiment. Method 200 begins with a communication device 100, such as a mobile, post-processing the conversation contents from the communication software 108, such as LINE for scheduling use. At block 202, the user may display said conversation contents and select one of said conversation contents. At block 204, the user touches a date/time stored in said selected conversation content on the display of the mobile. At block 206, a determination is made as to whether an auto-link has started or not after touching the date/time. If yes, at block 208, the communication software is connecting with a calendar via a scheduling module. At block 210, the user may search and record a corresponding date/time on the calendar by using the scheduling module according to the date/time from the conversation content.

Referring back to block 206, if not, at block 210, another determination is made, then the date/time is regarded as the general conversation content at block 212. In some embodiments, referring back to block 208, once a corresponding date/time on the calendar is searched and recorded by the scheduling module, the user may further input some words in a frame of the corresponding date/time on the calendar at block 214. In one embodiment, wherein the calendar is set in a mobile. In some embodiments, wherein the calendar is set in an internet (such as google calendar). In some embodiments, the user may also input a date/time into a input dialog at block 216, then continue the steps 206-214.

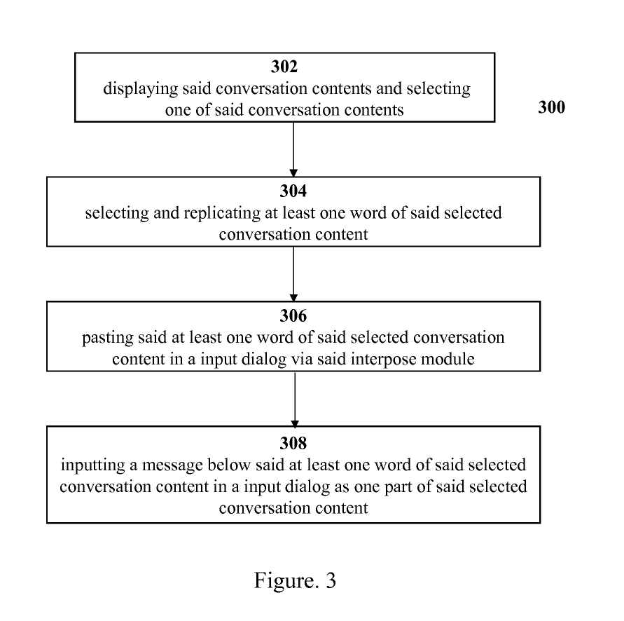

As illustrated in FIG. 3, while the user is interested in at least one word in a conversation content, the interpose module in the conversation content processing module may be provided for the user to select at least one word, then replicate and paste at least one word in the input dialog in order to interpose some messages below the at least one word, the invention provides embodiments of steps 302-308 of the method 300 for interposing, which the steps are illustrated as follows. At block 302, the user displays conversation contents and selects one of said interesting conversation contents, then selects and replicates at least one word of said selected interesting conversation content at block 304. At block 306, the user utilizes a interpose module to paste said at least one word of said selected conversation content in a input dialog; a new message inputted by the user is below the at least one word of said selected conversation content in a input dialog as one part of said selected conversation content at block 308. In some embodiments, wherein the new message may be represented in words, pictures and video. In some embodiments, the replication of said at least one word of said selected conversation content may be dragged into the input dialog.

In some embodiments, the user may use the interpose module to combine at least one word of the conversation content with a profile photo (e.g. the friend's profile photo or said photo which is combined with the friend's name), then dragged them into the input dialog.

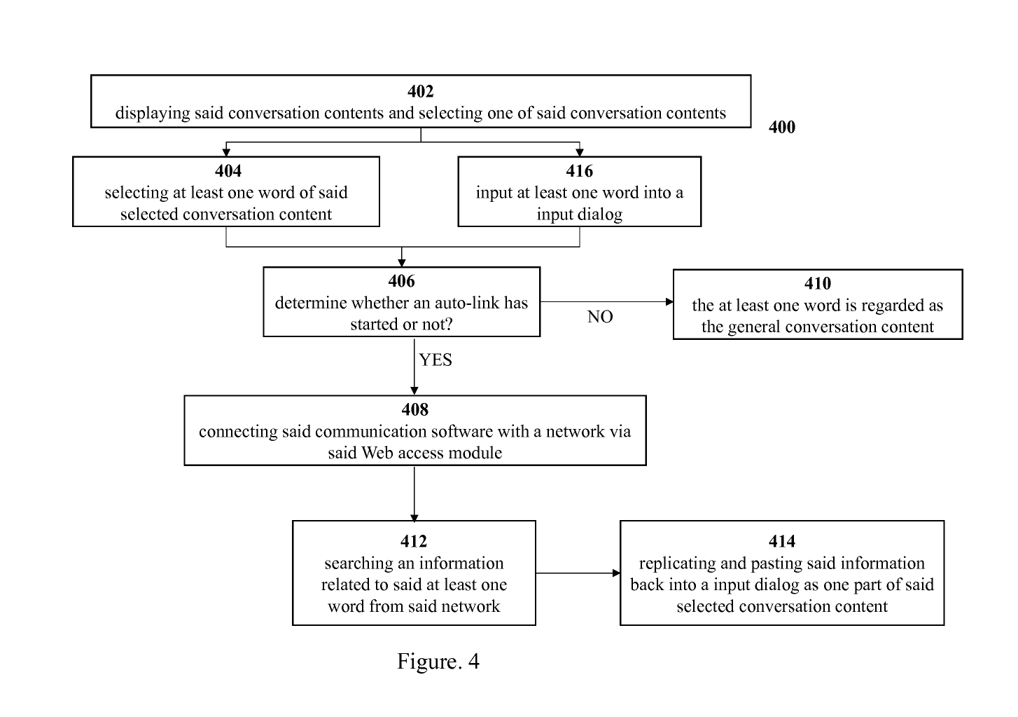

FIG. 4 illustrates a process for Web accessing using a conversation content processing module according to one embodiment. Method 400 begins with a communication device 100, such as a mobile, post-processing the conversation contents from the communication software 108, such as LINE for Web accessing use. At block 402, the user may display conversation contents and select one of said conversation contents. At block 404, the user may select at least one word of said selected conversation content. At block 406, a determination is made as to whether an auto-link has started or not while selecting said at least one word. If yes, at block 408, the communication software is connecting with a network via a Web access module. At block 412, the Web access module may search an information related to the at least one word of the conversation content.

Referring back to block 406, if not, at block 410, another determination is made, then the at least one word is regarded as the general conversation content. In some embodiments, referring back to block 412, once the information, such as website information, is searched, the user may further replicate and paste the information back to the input dialog at block 414, then the information will be one part of said selected conversation content through the input dialog. In some embodiments, the user may also input at least one word (e.g. apple) into a input dialog at block 416, then continue the steps 406-414.

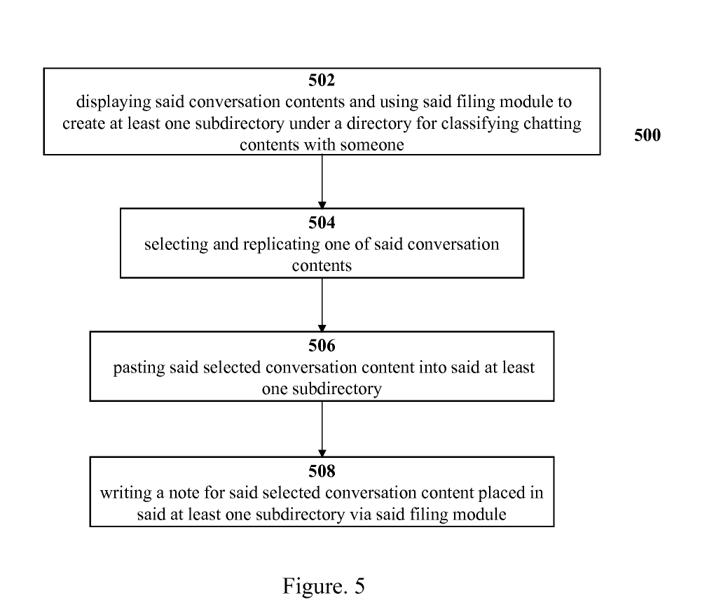

As illustrated in FIG. 5, while the user may build files for different conversation contents by using a filing module, and the invention provides embodiments of steps 502-508 of the method 500 for filing.

As shown in a step 502, the user displays conversation contents and creates at least one subdirectory under a directory, such as friend's name and conversation contents, for classifying chatting contents with someone by using a filing module (e.g. John/work/or John/read/).

As shown in a step 504, the user selects and replicates one of conversation contents.

As shown in a step 506, the user may paste said selected conversation content into the at least one subdirectory.

As shown in a step 508, the user may further use the filing module to write a note for said selected conversation content placed in the at least one subdirectory.

In some embodiments, wherein the at least one subdirectory may be named for said selected conversation content (e.g. John/read/a good book).

Methods 200, 300, 400 and 500 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, methods 200, 300, 400, 500 is performed by the device of FIG. 1 for post-processing conversation contents.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs which are not illustrated or described.

Various embodiments of the present invention may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

One or more modules, components, or elements described throughout this document, such as the ones shown within or associated with an embodiment of a DRAM enhancement mechanism may include hardware, software, and/or a combination thereof. In a case where a module includes software, the software data, instructions, and/or configuration may be provided via an article of manufacture by a machine/electronic device/hardware. An article of manufacture may include a machine accessible/readable medium having content to provide instructions, data, etc.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, read-only memory (ROM), random access memory (RAM), erasable programmable read-only memory (EPROM), EEPROM, magnet or optical cards, flash memory, or other type of media/machine-readable medium suitable for storing electronic instructions. Moreover, the present invention may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1.-6. (canceled)

7. A post-processing method for conversation contents in a communication software stored in a storage media in a communication device having a display and a interpose module in said storage media, comprising the steps of:
displaying said conversation contents and selecting one of said conversation contents;
selecting and replicating at least one word of said selected conversation content;
pasting said at least one word of said selected conversation content in a input dialog via said interpose module; and
inputting a message below said at least one word of said selected conversation content in a input dialog as one part of said selected conversation content.

8. The post-processing method for conversation contents in a communication software according to claim 7, wherein said at least one word of said conversation content is combined with a profile photo by using said interpose module.

9. The post-processing method for conversation contents in a communication software according to claim 7, wherein said message may be represented in words, pictures and video.

10. The post-processing method for conversation contents in a communication software according to claim 7, the replication of said at least one word of said selected conversation content may be dragged into the input dialog.

11. The post-processing method for conversation contents in a communication software according to claim 7, wherein said interpose module is located in a conversation content processing module and coupled with said communication software.

12. A post-processing method for conversation contents in a communication software stored in a storage media in a communication device having a display and a Web access module in said storage media, comprising the steps of:
displaying said conversation contents and selecting one of said conversation contents;
selecting at least one word of said selected conversation content;
connecting said communication software with a network via said Web access module; and
searching an information related to said at least one word from said network.

13. The post-processing method for conversation contents in a communication software according to claim 12 further comprising additional steps of:
replicating and pasting said information back into a input dialog as one part of said selected conversation content.

14. The post-processing method for conversation contents in a communication software according to claim 12, wherein said information further in represented in words, pictures or video.

15. The post-processing method for conversation contents in a communication software according to claim 12 further comprising an additional step of determining if starting an auto-link while selecting said at least one word.

16. The post-processing method for conversation contents in a communication software according to claim 12, wherein said Web access module is located in a conversation content processing module and coupled with said communication software.

17. A post-processing method for conversation contents in a communication software stored in a storage media in a communication device having a display and a filing module in said storage media, comprising the steps of:
displaying said conversation contents and using said filing module to create at least one subdirectory under a directory for classifying chatting contents with someone;
selecting and replicating one of said conversation contents;
pasting said selected conversation content into said at least one subdirectory; and
writing a note for said selected conversation content placed in said at least one subdirectory via said filing module.

18. The post-processing method for conversation contents in a communication software according to claim 17, wherein said at least one subdirectory may be named for said selected conversation content.

19. The post-processing method for conversation contents in a communication software according to claim 17, wherein said filing module is located in a conversation content processing module and coupled with said communication software.
